(19) United States
(12) Patent Application Publication
(10) Pub. No.: US 2015/0121963 A1
(43) Pub. Date: May 7, 2015

(54) GLASS PRODUCT MANUFACTURING METHOD AND GLASS PRODUCT MANUFACTURING APPARATUS

(71) Applicant: MURATA MANUFACTURING CO., LTD., Nagaokakyo-Shi (JP)

(72) Inventor: Satoru Hachinohe, Nagaokakyo-Shi (JP)

(21) Appl. No.: 14/597,287

(22) Filed: Jan. 15, 2015

Related U.S. Application Data
(63) Continuation of application No. PCT/JP2013/068132, filed on Jul. 2, 2013.

(30) Foreign Application Priority Data
Jul. 25, 2012 (JP) 2012-164468

(51) Int. Cl. C03B 23/00; H05B 3/00; C03B 23/26

(52) U.S. Cl. CPC C03B 23/0086; C03B 23/26; H05B 3/0004
USPC 65/102; 65/275

(57) ABSTRACT

A glass product manufacturing method that includes a step of disposing a workpiece configured of a glass material between two mutually-opposing punches, a step of starting to apply a pulsed current to the workpiece, and a step of starting to apply pressure to the workpiece using the two punches. The glass product is obtained from the workpiece through a discharge plasma process that causes the workpiece to deform in a state where the temperature of the workpiece has been increased by the application of the pulsed current.

### CROSS REFERENCE TO RELATED APPLICATIONS

The present application is a continuation of International application No. PCT/JP2013/068132, filed Jul. 2, 2013, which claims priority to Japanese Patent Application No. 2012-164468, filed Jul. 25, 2012, the entire contents of each of which are incorporated herein by reference.

### FIELD OF THE INVENTION

The present invention relates to glass product manufacturing methods and glass product manufacturing apparatuses. A glass lens can be given as an example of the stated glass product.

### BACKGROUND OF THE INVENTION

Japanese Unexamined Patent Application Publication No. 2011-16671 (Patent Document 1) discloses a glass lens manufacturing method that employs a heat imprint technique to form a glass plate, serving as a workpiece, into a glass lens by pressing the glass plate into a mold at a temperature greater than or equal to a glass-transition temperature Tg of the glass plate.

Meanwhile, Japanese Unexamined Patent Application Publication No. 2011-184257 (Patent Document 2) discloses a glass lens manufacturing method in which a workpiece configured of a glass material containing Bi₂O₃ is processed (pre-formed) based on a processing surface shape of a shaping mold, after which the workpiece configured of the glass material is annealed at a temperature greater than or equal to the glass-transition temperature Tg of the glass material but less than or equal to a yield temperature Is and then processed by pressing the workpiece configured of the glass material into the shaping mold.

In the glass lens manufacturing methods disclosed in Patent Documents 1 and 2, the workpiece configured of the glass material is processed using the glass-transition temperature Tg and the yield temperature Is of the glass material as a benchmark. Typically, the processing temperature during pre-forming is between the glass-transition temperature Tg and the yield temperature Ts of the glass material, and the processing temperature during pressure-forming is 30 to 50° C. higher than the yield temperature Ts.

Incidentally, International Publication No. WO2011/089971 (Patent Document 3) discloses deforming a semiconductor crystal into a desired shape such as a lens through a discharge plasma processing technique that processes a workpiece by raising the temperature of the workpiece interposed between two punches by applying a pulsed current between the two punches. However, this document makes no mention of the manufacture of glass products in general.

Patent Document 1: Japanese Unexamined Patent Application Publication No. 2011-16671

Patent Document 2: Japanese Unexamined Patent Application Publication No. 2011-184257

Patent Document 3: International Publication No. WO2011/089971

### SUMMARY OF THE INVENTION

In recent years, the glass-transition temperature Tg and the yield temperature Is of glass materials are increasing in order to realize smaller and thinner glass lenses. Accordingly, the processing temperature of a workpiece configured of a glass material has increased, and molds used in the formation thereof as well as surface coating materials of the molds are being subjected to high temperatures. There is thus a problem in that molds and surface coating materials are easily damaged by thermal loads, which shortens the product lifespan of the molds, the surface coating materials, and the like. A surface coating material is configured of DLC (diamond-like carbon), for example, and is provided on the surface of a mold so that the workpiece can separate from the mold with ease.

Meanwhile, while the processing temperature of workpieces configured of glass materials is increasing, glass lens manufacturing apparatuses are increasing and decreasing temperatures more rapidly than before during processing in order to reduce manufacturing times. There is thus a further problem in that the manufacturing apparatuses are becoming larger and more complex, and the costs of such manufacturing apparatuses are increasing.

Accordingly, it is an object of the present invention to provide a glass product manufacturing method and a glass product manufacturing apparatus capable of obtaining a glass product having a desired shape, with a mold used for formation, a surface coating material of the mold for the glass product, and the like not being easily damaged by thermal loads, and capable of simplifying the structure of the glass product manufacturing apparatus.

To achieve the aforementioned object, a glass product manufacturing method according to the present invention includes a step of disposing a workpiece configured of a glass material in a sandwiched state between two mutually-opposing punches, a step of starting to apply a pulsed current to the workpiece, and a step of starting to apply pressure to the workpiece using the two punches. A glass product is then obtained from the workpiece through a discharge plasma process that causes the workpiece to deform in a state where the temperature of the workpiece has been increased by the application of the pulsed current.

A glass product manufacturing apparatus according to the present invention is an apparatus that manufactures a glass product from a workpiece configured of a glass material by using a discharge plasma process to deform the workpiece while the temperature of the workpiece has been increased by a pulsed current, and includes a pulsed current application portion for applying the pulsed current to the workpiece, and a holding portion for holding the workpiece in a sandwiched state and pressurizing the workpiece.

According to the present invention, a glass product having a desired shape can be manufactured, and a mold used in the forming, a surface coating material of the mold, and so on are not easily damaged by thermal loads. Furthermore, a temperature is increased by applying a pulsed current, which makes it possible to simplify the structure of the glass product manufacturing apparatus.

### BRIEF DESCRIPTION OF THE DRAWINGS

FIG. 1 is a graph illustrating a temperature and applied pressure profile in a glass product manufacturing method based on a conventional technique.

FIG. 2 is a flowchart illustrating a glass product manufacturing method according to an embodiment of the present invention.

FIG. 3 is a conceptual diagram illustrating a glass product manufacturing apparatus according to an embodiment of the present invention.

FIG. 4 is a graph illustrating an electrical current and applied pressure profile in a glass product manufacturing method according to an embodiment of the present invention.

FIG. 5 is a conceptual diagram illustrating the interior of a chamber in a glass product manufacturing apparatus used in a glass product manufacturing method based on a conventional technique.

FIG. 6 is a conceptual diagram illustrating the interior of a chamber in a glass product manufacturing apparatus used in a glass product manufacturing method according to an embodiment of the present invention.

FIG. 7 is a graph illustrating an electrical current, temperature, displacement amount, and applied pressure profile according to a working example of an embodiment of the present invention.

### DETAILED DESCRIPTION OF THE PREFERRED EMBODIMENTS

When considering the present invention, the inventor used a glass product manufacturing method based on a conventional technique such as that described below as a basis of comparison.

In the glass product manufacturing method based on the conventional technique, a glass product is manufactured by heating two punches and a die (sleeve) in which a workpiece configured of a glass material is disposed using a heating element provided in the periphery thereof, and then pressing and forming the workpiece using the punches when a processing temperature based on a glass-transition temperature Tg and a yield temperature Is of the glass material is reached. The processing conditions for the workpiece are determined based on a temperature measured using a thermocouple provided in the punches. The thermocouple is embedded in the punches, embedded in the die, disposed near the heating element, or the like.

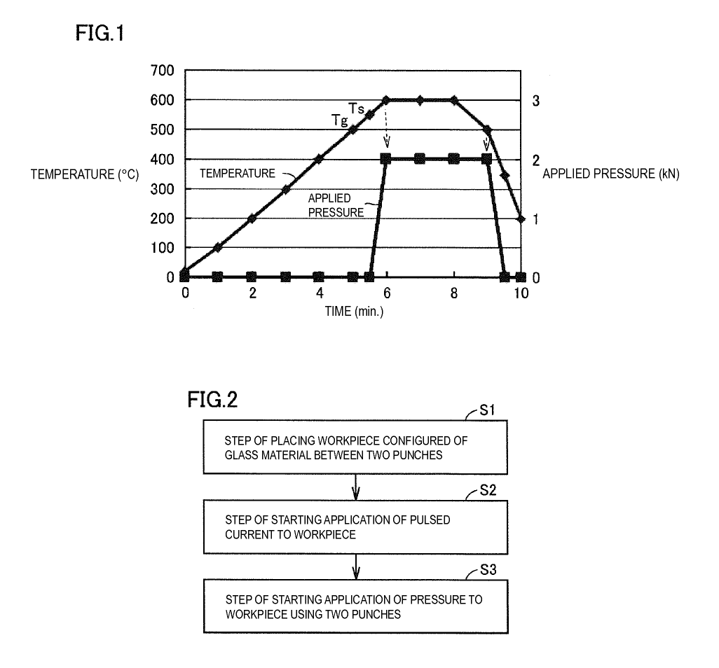

FIG. 1 is a graph illustrating a temperature and applied pressure profile in the glass product manufacturing method based on the conventional technique. As shown in FIG. 1, in the glass product manufacturing method according to the conventional technique, the workpiece is not pressurized while the temperature of the punches and the die in which the workpiece is disposed is rising due to the heating element. Instead, the workpiece begins to be pressurized by the punches when the yield temperature Is of the glass material has been exceeded by 30 to 50° C., and the applied pressure is released when the temperature begins to drop and drops below the glass-transition temperature Tg, after which the workpiece begins cooling. Radiational cooling, quick cooling blowing with air, N₂ gas, or the like, and so on can be given as examples of the cooling method.

### EMBODIMENT

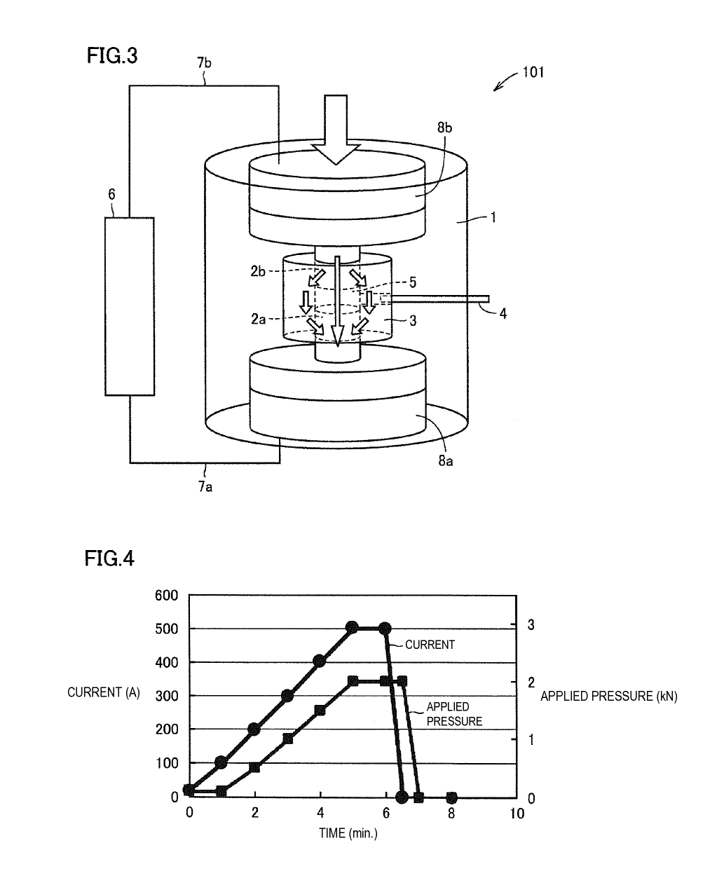

A glass product manufacturing method and a glass product manufacturing apparatus according to a first embodiment of the present invention will be described with reference to FIGS. 2 to 4. FIG. 2 is a flowchart illustrating a glass product manufacturing method according to the present embodiment. FIG. 3 is a conceptual diagram illustrating a discharge plasma processing apparatus serving as the glass product manufacturing apparatus used in the glass product manufacturing method according to the present embodiment.

As shown in FIG. 3, a discharge plasma processing apparatus 101 includes a chamber 1, two punches 2a and 2b disposed so as to oppose each other vertically, a cylindrical die 3 that surrounds the punches 2a and 2b, a thermocouple 4, a DC pulse power source 6, wires 7a and 7b, and displacement portions 8a and 8b. The punches 2a and 2b are each conductive. The punches 2a and 2b and the die 3 are disposed within the chamber 1. A workpiece 5 configured of a glass material is disposed so as to be interposed between the two punches 2a and 2b within the die 3. The thermocouple 4 is disposed so that one end portion thereof extends into the die 3 in order to measure a temperature of the workpiece 5 during processing. The punches 2a and 2b are anchored to the displacement portions 8a and 8b, respectively, and the displacement portions 8a and 8b cause the respective punches 2a and 2b to displace in the vertical direction. The DC pulse power source 6 is electrically connected to the punches 2a and 2b via the wires 7a and 7b.

The discharge plasma processing apparatus 101 manufactures a glass product by processing the workpiece 5, where the workpiece 5 is pressurized as a result of at least one of the punches 2a and 2b being displaced due to the displacement portions 8a and 8b and a pulsed current is applied by the DC pulse power source 6 between the punches 2a and 2b. In other words, the discharge plasma processing apparatus 101 is an apparatus for manufacturing a glass product from the workpiece 5 configured of the glass material, using a discharge plasma process that causes the workpiece 5 to deform while the temperature of the workpiece 5 has been increased by the pulsed current, and includes the DC pulse power source 6 serving as a pulsed current application portion for applying a pulsed current to the workpiece 5 and the punches 2a and 2b serving as a holding portion for holding the workpiece 5 in a sandwiched state and pressurizing the workpiece 5.

The glass product manufacturing method according to the present embodiment includes a step S1 of disposing the workpiece 5 configured of the glass material in a sandwiched state between the two mutually-opposing punches 2a and 2b, a step S2 of starting to apply the pulsed current to the workpiece 5, and a step S3 of starting to apply pressure to the workpiece 5 using the two punches 2a and 2b, and obtains a glass product from the workpiece 5 through a discharge plasma process that causes the workpiece 5 to deform under the applied pressure in a state where the temperature of the workpiece 5 has been increased by the application of the pulsed current.

FIG. 4 illustrates an electrical current and applied pressure profile in the glass product manufacturing method according to the present embodiment.

With the glass product manufacturing method according to the present embodiment, a glass product having a desired shape can be obtained. At this time, a mold used in the forming, a surface coating material of the mold, and so on are not easily damaged by thermal loads. Furthermore, with the glass product manufacturing method according to the present embodiment, the temperature of the workpiece is increased by applying the pulsed current, and thus the glass product manufacturing apparatus can be simplified.

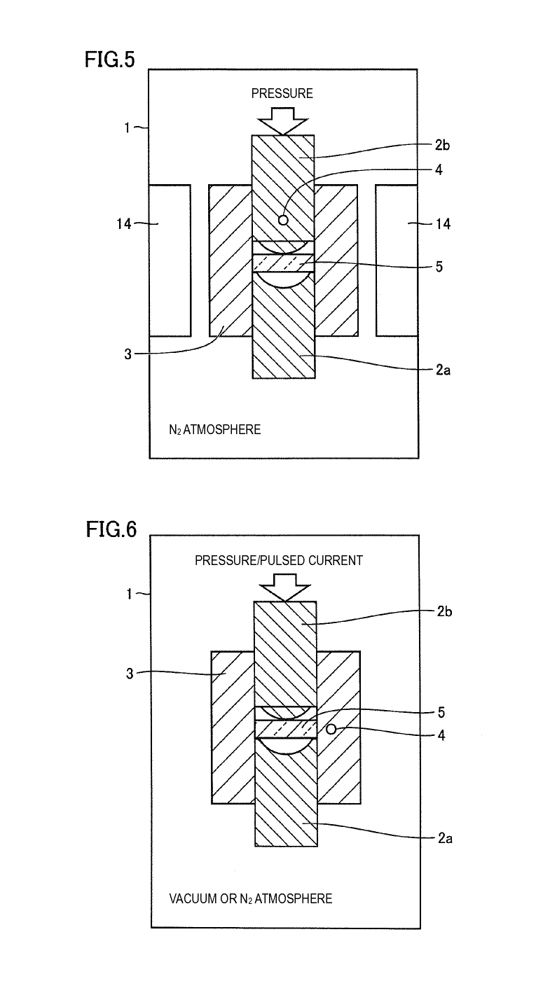

In the glass product manufacturing method according to the present embodiment, it is not necessary to process the workpiece configured of the glass material based on the glass-transition temperature Tg and the yield temperature Is of the glass material. FIG. 5 is a conceptual diagram illustrating the interior of the chamber 1 in a glass product manufacturing apparatus used in a glass product manufacturing method based on a conventional technique for comparative purposes.

According to the glass product manufacturing method based on the conventional technique, the two punches 2a and 2b and the die 3 in which the workpiece 5 configured of the glass material is disposed are heated by a heating element 14 disposed in the periphery thereof. At this time, the temperature is measured by the thermocouple 4, which is embedded in the punch 2b. The workpiece 5 configured of the glass material is pressurized and formed by the punch 2b being displaced downward at the point in time when the punches 2a and 2b and the die 3 reach the processing temperature, which is based on the glass-transition temperature Tg and the yield temperature Ts of the glass material. The processing conditions are determined based on the temperature measured using the thermocouple 4 provided in the punch 2b.

As opposed to this, FIG. 6 is a conceptual diagram illustrating the interior of the chamber 1 in the discharge plasma processing apparatus 101 serving as the glass product manufacturing apparatus used in the glass product manufacturing method according to the present embodiment. According to the present embodiment, the application of the pulsed current to the workpiece 5 and the pressurization of the workpiece 5 can be carried out simultaneously.

With the glass product manufacturing method according to the present embodiment, it is preferable for the step S2, in which the application of the pulsed current to the workpiece 5 is started, and the step S3, in which the pressurization of the workpiece 5 is started, to be carried out simultaneously. In this case, a standby time for the temperature to rise can be eliminated, and the overall processing time can be reduced as a result.

Likewise, it can be said that in the glass product manufacturing apparatus according to the present embodiment, it is preferable for the application of the pulsed current to the workpiece 5 by the pulsed current application portion and the pressurization of the workpiece 5 by the punches 2a and 2b serving as a holding portion to be carried out simultaneously.

In the glass product manufacturing method according to the present embodiment, the processing conditions for the workpiece 5 are determined based on the magnitude (current value) of the pulsed current and the application time. Specifically, the pressurization is started at the same time as the application of the pulsed current, and the applied pressure is released after the application of the pulsed current has been stopped. Accordingly, the glass product manufacturing method according to the present embodiment does not depend on the physical properties of the glass material (the glass-transition temperature Tg, the yield temperature Ts, and so on).

The glass product manufacturing method according to the present embodiment can manufacture a glass product such as a glass lens at a temperature in which the maximum temperature reached when processing the workpiece 5 is 50° C.-100° C. lower than the yield temperature Ts of the glass material. Accordingly, a mold used in the formation, a surface coating material of the mold, and so on will not be subjected to high temperatures. The mold and the surface coating material thus will not easily be damaged by thermal loads, which lengthens the product lifespan of the mold, the surface coating material, and the like. Furthermore, it is no longer necessary to increase and decrease temperatures rapidly when processing the workpiece 5, and thus the cost of the glass product manufacturing apparatus is reduced because complicating the glass product manufacturing apparatus, increasing the size of the apparatus, and so on are prevented.

In the discharge plasma processing apparatus 101 serving as a glass product manufacturing apparatus used in the glass product manufacturing method according to the present embodiment, a heating element such as that included in the glass product manufacturing apparatus used in the glass product manufacturing method based on the conventional technique is no longer necessary. Instead, the DC pulse power source 6 that applies the pulsed current to the workpiece 5 as shown in FIG. 3 is provided. Accordingly, it is no longer necessary to dispose a heating element within the chamber 1 of the discharge plasma processing apparatus 101, which in turn makes it possible to simplify the structure of the glass product manufacturing apparatus.

Furthermore, although it is necessary to provide an insulating structure that insulates heated components including the heating element in the glass product manufacturing apparatus used in the glass product manufacturing method based on the conventional technique, it is only necessary to provide an insulating structure that insulates the punches 2a and 2b and the die 3 in the discharge plasma processing apparatus 101 serving as the glass product manufacturing apparatus used in the glass product manufacturing method according to the present embodiment, which makes it possible to reduce the size of the glass product manufacturing apparatus.

In addition, with the discharge plasma processing apparatus 101 serving as the glass product manufacturing apparatus used in the glass product manufacturing method according to the present embodiment, it is not necessary to provide a program controller for controlling the temperature, as provided in the glass product manufacturing apparatus used in the glass product manufacturing method based on the conventional technique. Instead, a program controller for controlling the pulsed current is provided.

Note that the thermocouple 4 provided for the die 3, the punches 2a and 2b, and so on are used for detecting problems such as abnormal heat emission, rather than for temperature control.

(Working Example)

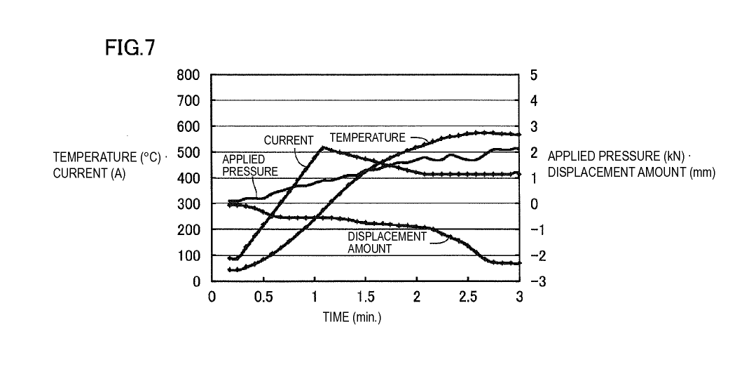

An example in which a glass lens was manufactured by processing a 15 mm-diameter, 3 mm-thick workpiece configured of a glass material whose yield temperature is 650° C. will be described as a more specific working example of the present invention. FIG. 7 is a graph illustrating an electrical current, temperature, displacement amount, and applied pressure profile according to the present working example. The temperature was measured by a thermocouple.

The 15 mm-diameter, 3 mm-thick workpiece configured of a glass material whose yield temperature is 650° C. was disposed between two punches, in an initial state in which an applied pressure of 0.1 kN was applied between the two punches. As shown in FIG. 7, the current value of the applied pulsed current was increased to 500 A during the first minute, reduced to 400 A during the next minute, and held in that state for another minute. Although the applied pressure was gradually increased to 2 kN during this period, the workpiece continued to deform without breaking, making it possible to manufacture the glass lens having a desired shape. The maximum temperature measured by the thermocouple provided in the die was 575° C. at this time.

Although an example of manufacturing a glass lens is described here, the present invention can be applied in the same manner when manufacturing glass products aside from glass lenses.

According to the glass product manufacturing method of the present invention, a workpiece can be pressurized and processed at a temperature that is lower than the yield temperature of the glass material, and a mold used in the forming, a surface coating material of the mold, and so on are not subjected to high temperatures for long periods of time. Accordingly, the mold, the surface coating material, and so on are not easily damaged by thermal loads, and the product lifespan of the mold, the surface coating material, and so on are increased as a result.

According to the present invention, a glass product such as a glass lens can be manufactured at a temperature in which the maximum temperature reached when processing the workpiece is 50° C.-100° C. lower than the yield temperature Is of the glass material. Accordingly, a mold used in the formation, a surface coating material of the mold, and so on will not be subjected to high temperatures. The mold and the surface coating material will thus not be easily damaged by thermal loads, which lengthens the product lifespan of the mold, the surface coating material, and the like. Furthermore, it is no longer necessary to increase and decrease temperatures rapidly when processing the workpiece, and thus the cost of the glass product manufacturing apparatus is reduced because complicating the glass product manufacturing apparatus, increasing the size of the apparatus, and so on are prevented.

Note that the embodiments disclosed herein are to be understood in all ways as exemplary and in no ways limiting. The scope of the present invention is defined by the appended claims rather than by the foregoing descriptions, and all modifications made within the same spirit and scope as the appended claims are intended to be encompassed thereby.

The present invention can be used in glass product manufacturing methods and glass product manufacturing apparatuses.

### REFERENCE SIGNS LIST

1 chamber
2a, 2b punch
3 die
4 thermocouple
5 workpiece
6 DC pulse power source
7a, 7b wire
8a, 8b displacement portion
14 heating element
101 discharge plasma processing apparatus

1. A glass product manufacturing method, the method comprising:
applying a pulsed current to a glass material workpiece so as to initiate a discharge plasma process that causes a temperature of the glass material workpiece to be increased; and
applying pressure to the glass material workpiece so as to cause the glass material workpiece to deform in a state where the temperature of the glass material workpiece has been increased by the application of the pulsed current.

2. The glass product manufacturing method according to claim 1, further comprising disposing the glass material workpiece between two mutually-opposing punches, and wherein the pressure is applied to the glass material workpiece using the two mutually-opposing punches.

3. The glass product manufacturing method according to claim 2, wherein the step of applying the pulsed current to the glass material workpiece and the step of applying pressure to the glass material workpiece using the two mutually-opposing punches are carried out simultaneously.

4. The glass product manufacturing method according to claim 1, wherein the step of applying the pulsed current to the glass material workpiece and the step of applying pressure to the glass material workpiece are carried out simultaneously.

5. The glass product manufacturing method according to claim 1, wherein the application of the pressure to the glass material workpiece is released after the application of the pulsed current to the glass material workpiece is stopped.

6. The glass product manufacturing method according to claim 1, wherein a maximum temperature reached when processing the glass material workpiece is 50° C.-100° C. lower than a yield temperature of the glass material workpiece.

7. A glass product manufacturing apparatus comprising:
a pulsed current application portion constructed to apply a pulsed current to a glass material workpiece so as to initiate a discharge plasma process that causes a temperature of the glass material workpiece to be increased; and
a holding portion constructed to hold and apply pressure to the glass material workpiece so as to cause the glass material workpiece to deform in a state where the temperature of the glass material workpiece has been increased by the application of the pulsed current.

8. The glass product manufacturing apparatus according to claim 7, wherein the application of the pulsed current to the glass material workpiece by the pulsed current application portion and the application of the pressure to the glass material workpiece by the holding portion are carried out simultaneously.

9. The glass product manufacturing apparatus according to claim 8, wherein the holding portion comprises two mutually-opposing punches.

10. The glass product manufacturing apparatus according to claim 7, wherein the holding portion comprises two mutually-opposing punches.

11. The glass product manufacturing apparatus according to claim 7, wherein the holding portion releases the pressure to the glass material workpiece after the pulsed current application portion stops application of the pulsed current to the glass material workpiece.

12. The glass product manufacturing apparatus according to claim 7, wherein a maximum temperature reached when processing the glass material workpiece is 50° C.-100° C. lower than a yield temperature of the glass material workpiece.
